(19) United States
(12) Patent Application Publication
(10) Pub. No.: US 2013/0278149 A1
(43) Pub. Date: Oct. 24, 2013

(54) APPARATUS, SYSTEM AND METHOD FOR MULTI-CHANNEL ILLUMINATION

(71) Applicants: Dirk Jan Van Kaathoven, Eindhoven (NL); Ralph Kurt, Eindhoven (NL); Jorrit Ernst De Vries, Culemborg (NL)

(72) Inventors: Dirk Jan Van Kaathoven, Eindhoven (NL); Ralph Kurt, Eindhoven (NL); Jorrit Ernst De Vries, Culemborg (NL)

(21) Appl. No.: 13/996,008

(22) PCT Filed: Dec. 12, 2011
(86) PCT No.: PCT/IB2011/055609

§ 371 Date: Jun. 20, 2013

(30) Foreign Application Priority Data
Dec. 21, 2010 (US) 61425512

(51) Int. Cl. H05B 33/08

(52) U.S. Cl. CPC H05B 33/0857; H05B 33/0869
USPC 315/152; 315/294

(57) ABSTRACT

Disclosed are systems and methods for providing multi-channel illumination. A reflector and at least four solid state light sources are operable to emit light. A plurality of combinations of the solid state light sources are identified, where each of the combinations is operable to emit light that matches a target color point. The combinations are ranked based on their respective luminous flux value, and at least one of the combinations is selected based on the rank. A duty cycle of a control signal of each light source of the selected combinations is determined to control light emitted from the reflector.

### TECHNICAL FIELD

The present invention is directed generally to systems and methods of providing mixed light. More particularly, various inventive methods and apparatus disclosed herein relate to controlling multiple primary color light sources to provide light at a desired color point.

### BACKGROUND

Digital lighting technologies, i.e. illumination based on semiconductor light sources, such as light-emitting diodes (LEDs), offer a viable alternative to traditional fluorescent, HID, and incandescent lamps. Functional advantages and benefits of LEDs include high energy conversion and optical efficiency, durability, lower operating costs, and many others. Recent advances in LED technology have provided efficient and robust full-spectrum lighting sources that enable a variety of lighting effects in many applications. Some of the fixtures embodying these sources feature a lighting module, including one or more LEDs capable of producing different colors, e.g. red, green, and blue, as well as a processor for independently controlling the output of the LEDs in order to generate a variety of colors and color-changing lighting effects, for example, as discussed in detail in U.S. Pat. Nos. 6,016,038 and 6,211,626.

Mixed light at a particular color point can be generated by combining different primary color light sources into a resulting color. For example, when light of the three primary colors (e.g., red, green, and blue) is combined, every color in the gamut of those three primary colors can be achieved. When light of two primary colors is combined, only color points on a line between the two primary colors can be achieved. However, a problem arises when light from more than three primary colors is combined, because more than one combination of the primary colors is often available to achieve a desired color point in the gamut, and because these combinations can have significant differences in luminous flux output when compared with one another.

Known solutions to this problem choose one of the many primary color combinations that provide light at the desired color point and operate the light sources at selected duty cycles in an attempt to achieve the color point. However, as the output of the light sources change with time, or when a different color point is chosen, the known solutions do not smoothly control the transition between color points. This lack of a smooth transition between color points degrades the quality of the light and can be noticed by a viewer.

Thus, there is a need in the art to provide an illumination system and method that provides mixed light from a group of primary color light sources, at a desired color point, with robust control for smooth transition when the desired color point changes across the color gamut.

### SUMMARY

The present disclosure is directed to inventive methods and apparatus for providing illumination from a lighting source. For example, a reflector includes an array of solid state light sources. Each light source emits light of a primary color, and different combinations of the light sources emit light at the same color point on the gamut. A control system ranks the plurality of choices that emit light at a particular color point, and selects the optimum combination of light sources from the many combinations that emit light at the color point with optimal characteristics.

Generally, in one aspect, an illumination system includes a reflector and at least four solid state light sources operable to emit light. The illumination system also includes a controller to identify a plurality of combinations of the solid state light sources, where each of the combinations is operable to emit light that matches a target color point. The controller ranks the combinations based on their respective luminous flux value, and selects one of the combinations based on the rank. The controller determines a duty cycle of a control signal of each light source of the selected combination to control light emitted from the reflector by the selected combination.

In one aspect, a method provides illumination from a lighting source that employs a plurality of solid state light sources. The method identifies a plurality of combinations of the plurality of solid state light sources, where each of the plurality of combinations is operable to emit light that matches a target color point. The method also ranks the combinations based on a respective luminous flux value of each of the plurality of combinations, and selects one of the plurality of combinations as a selected combination based on the ranking. The method determines a duty cycle of a control signal of each light source of the selected combination, and can modulate the duty cycle of each light source of the selected combination to control light emitted by the selected combination.

In one aspect, a computer readable medium is provided encoded with a program for execution on a processor that, when executed on the processor, performs a method of providing illumination from a lighting source having a plurality of solid state light sources. The method identifies multiple combinations of the solid state light sources, where each of the combinations is operable to emit light that matches a target color point. The method ranks the combinations based on a respective luminous flux value of each of the combinations, and selects a plurality of the combinations based on the ranking. The method determines individual duty cycles for each light source individually for each of the selected plurality of the combinations, and determines total duty cycles for each light source, based on the individual duty cycles. The method also controls light emitted by the selected combination based on the total duty cycles.

In one embodiment, a selected one of the plurality of combinations emits light having a luminous flux value greater than the respective luminous flux value emitted by each of the other of the plurality of combinations. In some embodiments, a duty cycle budget is determined based on the duty cycle of each light source of the selected combination, and a second of the plurality of combinations is selected based on the rank. A duty cycle of each light source of the second selected combination can also be determined based on the duty cycle budget. In one embodiment, a total duty cycle of the light sources is determined based on the duty cycle of each light source of the selected combination and the duty cycle of each light source of the second selected combination. A cumulative duty cycle can also be determined to be greater than one for at least one of the light sources provided by the plurality of combinations.

In one embodiment, a compound light source is defined based on two of the at least four light sources, and a luminous flux value of the compound light source is identified based on luminous flux of the two light sources. A duty cycle of the compound light source is determined, and the compound light source is employed in combination with the light sources that form the plurality of combinations. In one embodiment, the illumination system includes a photosensitive detector. The reflector can be a tubular reflector and may include a lightguide to provide light from at least one of the light sources to the photosensitive detector. Duty cycles can be adjusted based on information received from the photosensitive detector. In some embodiments, the light sources emit a different primary color of light, and wherein each of the at least four solid state light sources includes at least one light emitting diode.

In one embodiment, a duty cycle of at least one light source that is common to more than one selected combination is scaled based on the duty cycle budget. The duty cycle of each light source of the selected combination can also be adjusted to maintain the light emitted by the selected combination at the target color point. In some embodiments, the individual duty cycles are compared with a duty cycle budget, and at least one individual duty cycle is scaled to determine a total duty cycle.

As used herein for purposes of the present disclosure, the term “LED” should be understood to include any electroluminescent diode or other type of carrier injection/junction-based system that is capable of generating radiation in response to an electric signal. Thus, the term LED includes, but is not limited to, various semiconductor-based structures that emit light in response to current, light emitting polymers, organic light emitting diodes (OLEDs), electroluminescent strips, and the like. In particular, the term LED refers to light emitting diodes of all types (including semi-conductor and organic light emitting diodes) that may be configured to generate radiation in one or more of the infrared spectrum, ultraviolet spectrum, and various portions of the visible spectrum (generally including radiation wavelengths from approximately 400 nanometers to approximately 700 nanometers). Some examples of LEDs include, but are not limited to, various types of infrared LEDs, ultraviolet LEDs, red LEDs, blue LEDs, green LEDs, yellow LEDs, amber LEDs, orange LEDs, and white LEDs (discussed further below). It also should be appreciated that LEDs may be configured and/or controlled to generate radiation having various bandwidths (e.g., full widths at half maximum, or FWHM) for a given spectrum (e.g., narrow bandwidth, broad bandwidth), and a variety of dominant wavelengths within a given general color categorization.

For example, one implementation of an LED configured to generate essentially white light (e.g., a white LED) may include a number of dies which respectively emit different spectra of electroluminescence that, in combination, mix to form essentially white light. In another implementation, a white light LED may be associated with a phosphor material that converts electroluminescence having a first spectrum to a different second spectrum. In one example of this implementation, electroluminescence having a relatively short wavelength and narrow bandwidth spectrum “pumps” the phosphor material, which in turn radiates longer wavelength radiation having a somewhat broader spectrum.

It should also be understood that the term LED does not limit the physical and/or electrical package type of an LED. For example, as discussed above, an LED may refer to a single light emitting device having multiple dies that are configured to respectively emit different spectra of radiation (e.g., that may or may not be individually controllable). Also, an LED may be associated with a phosphor that is considered as an integral part of the LED (e.g., some types of white LEDs). In general, the term LED may refer to packaged LEDs, non-packaged LEDs, surface mount LEDs, chip-on-board LEDs, T-package mount LEDs, radial package LEDs, power package LEDs, LEDs including some type of encasement and/or optical element (e.g., a diffusing lens), etc.

The term “light source” should be understood to refer to any one or more of a variety of radiation sources, including, but not limited to, LED-based sources (including one or more LEDs as defined above), incandescent sources (e.g., filament lamps, halogen lamps), fluorescent sources, phosphorescent sources, high-intensity discharge sources (e.g., sodium vapor, mercury vapor, and metal halide lamps), lasers, other types of electroluminescent sources, pyro-luminescent sources (e.g., flames), candle-luminescent sources (e.g., gas mantles, carbon arc radiation sources), photo-luminescent sources (e.g., gaseous discharge sources), cathode luminescent sources using electronic satiation, galvano-luminescent sources, crystallo-luminescent sources, kine-luminescent sources, thermo-luminescent sources, triboluminescent sources, sonoluminescent sources, radioluminescent sources, and luminescent polymers.

A given light source may be configured to generate electromagnetic radiation within the visible spectrum, outside the visible spectrum, or a combination of both. Hence, the terms “light” and “radiation” are used interchangeably herein. Additionally, a light source may include as an integral component one or more filters (e.g., color filters), lenses, or other optical components. Also, it should be understood that light sources may be configured for a variety of applications, including, but not limited to, indication, display, and/or illumination. An “illumination source” is a light source that is particularly configured to generate radiation having a sufficient intensity to effectively illuminate an interior or exterior space. In this context, “sufficient intensity” refers to sufficient radiant power in the visible spectrum generated in the space or environment (the unit “lumens” often is employed to represent the total light output from a light source in all directions, in terms of radiant power or “luminous flux”) to provide ambient illumination (i.e., light that may be perceived indirectly and that may be, for example, reflected off of one or more of a variety of intervening surfaces before being perceived in whole or in part).

The term “spectrum” should be understood to refer to any one or more frequencies (or wavelengths) of radiation produced by one or more light sources. Accordingly, the term “spectrum” refers to frequencies (or wavelengths) not only in the visible range, but also frequencies (or wavelengths) in the infrared, ultraviolet, and other areas of the overall electromagnetic spectrum. Also, a given spectrum may have a relatively narrow bandwidth (e.g., a FWHM having essentially few frequency or wavelength components) or a relatively wide bandwidth (several frequency or wavelength components having various relative strengths). It should also be appreciated that a given spectrum may be the result of a mixing of two or more other spectra (e.g., mixing radiation respectively emitted from multiple light sources).

For purposes of this disclosure, the term “color” is used interchangeably with the term “spectrum.” However, the term “color” generally is used to refer primarily to a property of radiation that is perceivable by an observer (although this usage is not intended to limit the scope of this term). Accordingly, the terms “different colors” implicitly refer to multiple spectra having different wavelength components and/or bandwidths. It also should be appreciated that the term “color” may be used in connection with both white and non-white light.

The term “color temperature” generally is used herein in connection with white light, although this usage is not intended to limit the scope of this term. Color temperature essentially refers to a particular color content or shade (e.g., reddish, bluish) of white light. The color temperature of a given radiation sample conventionally is characterized according to the temperature in degrees Kelvin (K) of a black body radiator that radiates essentially the same spectrum as the radiation sample in question. Black body radiator color temperatures generally fall within a range of from approximately 700 degrees K (typically considered the first visible to the human eye) to over 10,000 degrees K; white light generally is perceived at color temperatures above 1500-2000 degrees K.

Lower color temperatures generally indicate white light having a more significant red component or a “warmer feel,” while higher color temperatures generally indicate white light having a more significant blue component or a “cooler feel.” By way of example, fire has a color temperature of approximately 1,800 degrees K, a conventional incandescent bulb has a color temperature of approximately 2848 degrees K, early morning daylight has a color temperature of approximately 3,000 degrees K, and overcast midday skies have a color temperature of approximately 10,000 degrees K. A color image viewed under white light having a color temperature of approximately 3,000 degree K has a relatively reddish tone, whereas the same color image viewed under white light having a color temperature of approximately 10,000 degrees K has a relatively bluish tone.

The term “lighting fixture” is used herein to refer to an implementation or arrangement of one or more lighting units in a particular form factor, assembly, or package. The term “lighting unit” is used herein to refer to an apparatus including one or more light sources of same or different types. A given lighting unit may have any one of a variety of mounting arrangements for the light source(s), enclosure/housing arrangements and shapes, and/or electrical and mechanical connection configurations. Additionally, a given lighting unit optionally may be associated with (e.g., include, be coupled to and/or packaged together with) various other components (e.g., control circuitry) relating to the operation of the light source(s). An “LED-based lighting unit” refers to a lighting unit that includes one or more LED-based light sources as discussed above, alone or in combination with other non LED-based light sources. A “multi-channel” lighting unit refers to an LED-based or non LED-based lighting unit that includes at least two light sources configured to respectively generate different spectrums of radiation, wherein each different source spectrum may be referred to as a “channel” of the multi-channel lighting unit.

The term “controller” is used herein generally to describe various apparatus relating to the operation of one or more light sources. A controller can be implemented in numerous ways (e.g., such as with dedicated hardware) to perform various functions discussed herein. A “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), and field-programmable gate arrays (FPGAs).

In various implementations, a processor or controller may be associated with one or more storage media (generically referred to herein as “memory,” e.g., volatile and non-volatile computer memory such as RAM, PROM, EPROM, and EEPROM, floppy disks, compact disks, optical disks, magnetic tape, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects of the present invention discussed herein. The terms “program” or “computer program” are used herein in a generic sense to refer to any type of computer code (e.g., software or microcode) that can be employed to program one or more processors or controllers.

The term “addressable” is used herein to refer to a device (e.g., a light source in general, a lighting unit or fixture, a controller or processor associated with one or more light sources or lighting units, other non-lighting related devices, etc.) that is configured to receive information (e.g., data) intended for multiple devices, including itself, and to selectively respond to particular information intended for it. The term “addressable” often is used in connection with a networked environment (or a “network,” discussed further below), in which multiple devices are coupled together via some communications medium or media.

In one network implementation, one or more devices coupled to a network may serve as a controller for one or more other devices coupled to the network (e.g., in a master/slave relationship). In another implementation, a networked environment may include one or more dedicated controllers that are configured to control one or more of the devices coupled to the network. Generally, multiple devices coupled to the network each may have access to data that is present on the communications medium or media; however, a given device may be “addressable” in that it is configured to selectively exchange data with (i.e., receive data from and/or transmit data to) the network, based, for example, on one or more particular identifiers (e.g., “addresses”) assigned to it.

The term “network” as used herein refers to any interconnection of two or more devices (including controllers or processors) that facilitates the transport of information (e.g. for device control, data storage, data exchange, etc.) between any two or more devices and/or among multiple devices coupled to the network. As should be readily appreciated, various implementations of networks suitable for interconnecting multiple devices may include any of a variety of network topologies and employ any of a variety of communication protocols. Additionally, in various networks according to the present disclosure, any one connection between two devices may represent a dedicated connection between the two systems, or alternatively a non-dedicated connection. In addition to carrying information intended for the two devices, such a non-dedicated connection may carry information not necessarily intended for either of the two devices (e.g., an open network connection). Furthermore, it should be readily appreciated that various networks of devices as discussed herein may employ one or more wireless, wire/cable, and/or fiber optic links to facilitate information transport throughout the network.

The term “user interface” as used herein refers to an interface between a human user or operator and one or more devices that enables communication between the user and the device(s). Examples of user interfaces that may be employed in various implementations of the present disclosure include, but are not limited to, switches, potentiometers, buttons, dials, sliders, a mouse, keyboard, keypad, various types of game controllers (e.g., joysticks), track balls, display screens, various types of graphical user interfaces (GUIs), touch screens, microphones and other types of sensors that may receive some form of human-generated stimulus and generate a signal in response thereto.

The term “primary color” should be understood to refer to any color provided by a discrete light source, whether provided by a color LED, a phosphor alone or in combination with a filter, lens or other optical component. A primary color includes any color that can be combined with at least one other primary color to create a secondary color. It should be appreciated that the term “primary color” may be used in connection with a discrete light source that emits radiation at any frequency.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 illustrates a block diagram of an illumination system in accordance with an embodiment;

FIG. 2 illustrates a perspective view of an illumination system in accordance with an embodiment;

FIG. 3 illustrates a color point on a gamut obtainable from a plurality of primary color combinations, in accordance with an embodiment;

FIG. 4 illustrates a flow chart of a method of providing illumination from a lighting unit in accordance with an embodiment;

FIG. 5 illustrates a flow chart of a method of providing illumination from a lighting unit in accordance with an embodiment; and

FIG. 6 illustrates a flow chart of a method of providing illumination from a lighting unit in accordance with an embodiment.

### DETAILED DESCRIPTION

With more than one combination of primary colors resulting in a desired color point in the gamut, finding the optimum combination of those primary colors remains a problem. Applicants have recognized and appreciated that it would be beneficial to find a combination of light from multiple sources that emits light having optimum characteristics, such as flux, at the desired color point. In view of the foregoing, various embodiments and implementations of the present invention are directed to illumination systems and methods that identify a plurality of primary light source combinations that emit mixed light at a desired color point, and control the light sources to emit the mixed light at the color point with the highest achievable flux.

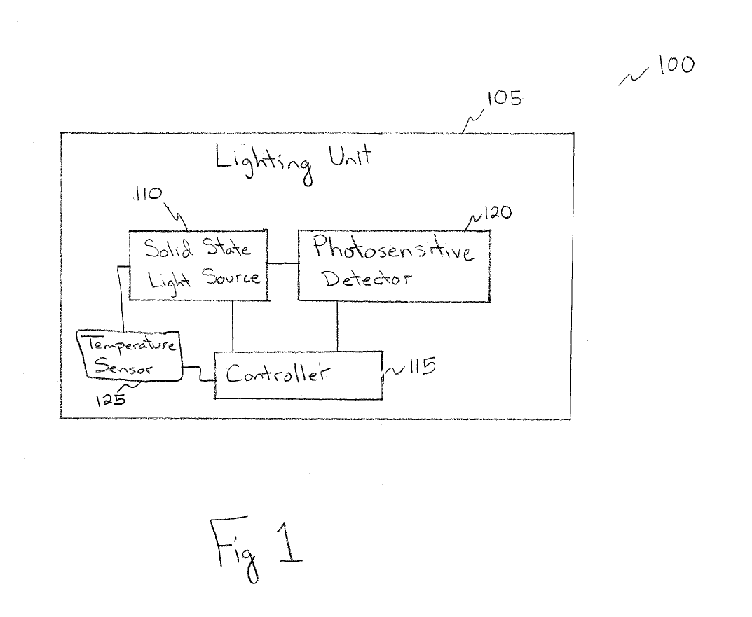

Referring to FIG. 1, in one embodiment, illumination system 100 includes at least one lighting unit 105. Lighting unit 105 includes a plurality of solid state light sources 110, such as one or more LEDs. For example, each light source 110 may include on or more LEDs that emit light of a primary color, such as red, green, blue, cyan, amber, royal, deep red, or white, among others. In one embodiment, lighting unit 105 includes at least four light sources 110, each configured to emit light of a different primary color. Lighting unit 105 can also include at least one controller 115, at least one photosensitive detector 120, and at least one temperature sensor 125. Controller 115 generally determines duty cycles of control signals that operate light sources 110, based for example on information from photosensitive detector 120 or temperature sensor 125, that can be used to determine luminous flux output and wavelength of the light sources, as well as predetermined information or desired outputs, such as a target color point. Controller 115 can be included in lighting unit 105, or separate from lighting unit 105.

In one embodiment, controller 115 operates light sources 110 at their calculated duty cycles. Lighting unit 105 mixes the light emitting from light sources 110 to provide a mixed light that can be output from lighting unit 105 to illuminate an object at the target color point with optimum output characteristics. For example, controller 115 can determine individual duty cycles of light sources 110 so that the mixed output light has a maximum achievable flux at the target color point.

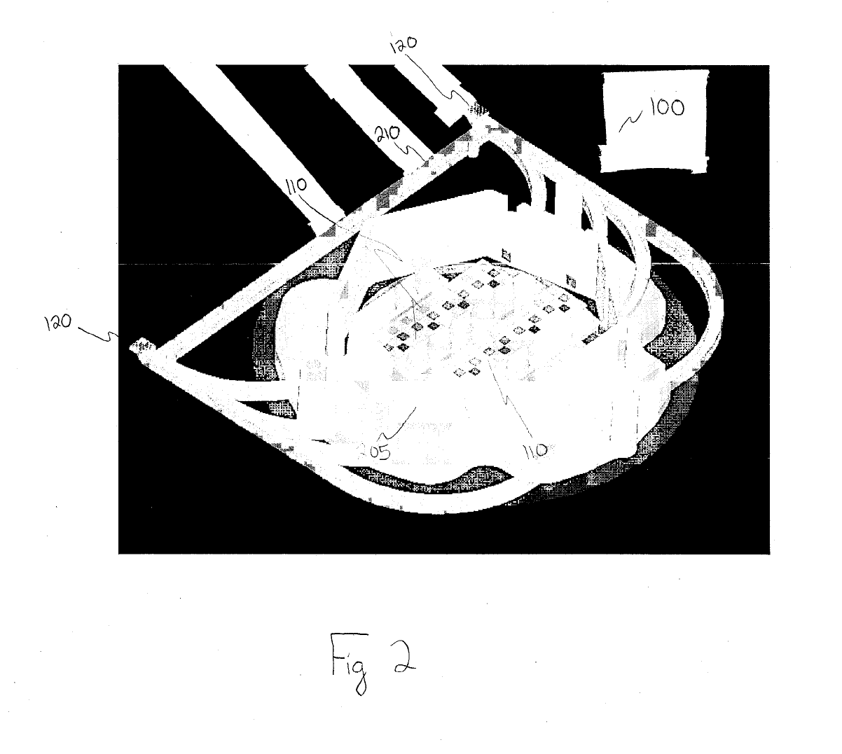

FIG. 2 depicts an example of illumination system 100. With reference to FIG. 2, in one embodiment, a plurality of light sources 110 are arranged to emit light toward at least one reflector 205. Reflector 205 includes a reflective inner surface, an entrance aperture, and an exit aperture. In one embodiment, light sources 110 form an array that emits light into the entrance aperture and out from the exit aperture. The light from various light sources 110 mixes in reflector 205 and exits via the exit aperture. The light can be collimated into a white light beam with a hard edge operable, for example, as a projected spot light in a theater. In one embodiment, the exit aperture is larger than the entrance aperture. Reflector 205 can be a tubular reflector, or various other shapes, including cylindrical and polygonal. In one embodiment, reflector 205 includes a plurality of lightguides 210. Light from at least one light source 110 follows at least one lightguide 210 to photosensitive detector 120, which can sense the luminous flux of the respective light source 110.

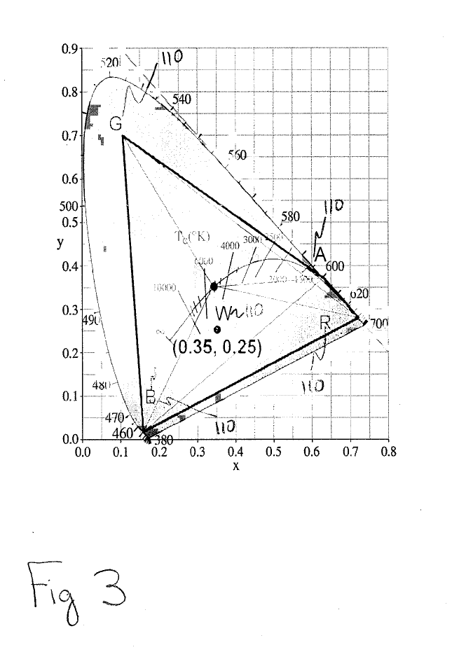

FIG. 3 illustrates a color point on a gamut obtainable from a plurality of primary color combinations. In the example of FIG. 3, five light sources 110 are present on the gamut, i.e, red (R), green (G), blue (B), amber (A) and white (W). Other light sources 110, such as cyan or magenta, are possible. The color points (x and y coordinates) that fall within the triangles created by combinations of any three light sources 110 can be obtained by mixing the light of the respective light sources 110. For example, the target color point having (x, y) coordinates of (0.35, 0.25) is depicted in FIG. 3. The combinations of light sources 110 whose triangles overlap this target color point can provide mixed light at this target color point. In this example, each of the BRW, BGR, BGA, and BAW combinations includes three light sources 110 that provide mixed light at target color point (0.35, 0.25). Further, the primary color combinations BGW, GAW, ARW, GAR, BAR, and GRW do not overlap the target color point, and are not capable of providing mixed light matching the target color point of FIG. 3, for example, see Table 1.

TABLE 1

| | BGW | GAW | ARW | BRW | BGR | GAR | BGA | BAR | GRW | BAW |
|---|---|---|---|---|---|---|---|---|---|---|
| Within Gamut? | No | No | No | Yes | Yes | No | Yes | No | No | Yes |

According to some embodiments, controller 115 evaluates these combinations and determines the duty cycles of a PWM control signal for the individual light sources 110 (e.g., R, G, B, A, and W) to provide mixed light at the target color point having the highest achievable luminous flux. For example, controller 115 identifies the target color point, which can be provided as an input to controller 115, and identifies the color points of light sources 110. Controller 115 also identifies or determines the maximum flux of light sources 110. From this input information controller 115 identifies the combinations of light sources 110 (e.g., the possible triangles on the (x, y) axis of the gamut, as in FIG. 3 and Table 1) that cover the target color point. Continuing with this example, controller 115 calculates the duty cycles of the individual light sources 110 that form the combinations that provide the target color. For example, where BRW, BGR, BGA, and BAW combinations each cover the target color point, controller 115 determines the duty cycle of a control signal for each of the blue, red, white, green, and amber light sources 110 for each of these combinations.

In one embodiment, controller 115 sums the duty cycles of each light source 110, for each combination when operated to match the target color point. According to this embodiment, a cumulative duty cycle for each light source is determined by adding together a value of the duty cycle for a selected primary color light source for each of the selected combination in which it appears. Thus, in the current example, the blue light source includes a duty cycle from each of the four selected combinations and each of the red, white, amber, and green light sources include duty cycles in two of the four selected combinations.

When the cumulative duty cycles of all light sources 110 that form part of a combination are each less than one, controller 115 can operate each light source 110 at the cumulative duty cycle and each light source 110 contributes to the mixed output light that matched the target color point. In one embodiment, however, at least one of these cumulative duty cycles is greater than one. For example, if the blue color source 110 duty cycle is 0.60 in the BRW combination and is 0.68 in the BGR combination, its cumulative duty cycle is 1.28. According to one embodiment, the blue color source 110 cannot, in this example, fully contribute to both the BRW and BGR combinations (i.e., a duty cycle ratio of greater than 100% is not possible), and controller 115 implements further operations to reduce the cumulative duty cycle of each light source 110 to a value not greater than 1.

According to some embodiments, controller 115 ranks the combinations according to their contribution to the total luminous flux. For example, the combinations of light sources 110 may be ranked in the following order, from highest to lowest flux: BRW, BAW, BGR, and BGA. Other primary color light source 110 combinations and rankings are possible, for example, to match different target color points in the gamut. Controller 115 selects the combination that contributes the most to the total flux (e.g., BRW), relative to the other combinations, and identifies the duty cycles of each light source 110 (B, R, and W) of the selected combination. These duty cycles are, in this example, subtracted from 1 (the total duty cycle budget) to obtain the remaining duty cycle budget available for light sources 110. For example, if blue light source 110 has a duty cycle of 0.59 in combination BRW, the remaining duty cycle budget for blue light source 110 for the remaining combinations is 0.41. Controller 115 then selects the remaining combination having the highest flux and compares the duty cycles of this second combination with the remaining duty cycle budget. The duty cycles of the second selected combination are subtracted from the remaining duty cycle budget, and can be scaled to fit within the budget. This process can repeat until each combination that covers the target color point has been included. In one embodiment, the duty cycle of, for example, one or more light sources included in the second selected combination exceeds the remaining duty cycle budget. In this example, controller 115 scales down the duty cycles of the light sources 110 that form the selected combination to maintain the duty cycles within the remaining budget. When scaled in this manner, the contribution of that selected combination to the mixed light output of lighting unit 105 (or reflector 205) is dimmed.

In one embodiment, controller 115 determines the duty cycles for the combinations of light sources 110 that match the target color point, and sums them for each light source 110 to determine the total duty cycle for each light source 110 to achieve light with the highest achievable flux at the target color point. For example, with reference to Table 1, blue (B) light source 110 is part of four combinations that can achieve output light at the target color point. Here, according to one embodiment, controller 115 sums the duty cycles of this light source for each combination, and scaled the duty cycles scaling to maintain the total duty cycle less than or equal to 1. Blue light source 110 in this example is operated at the summed duty cycle, which due to scaling and the total duty cycle budget is capped at 1. Controller 115 controls each light source 110 that is part of a matching combination together to determine the total duty cycle, and operates light sources 110 at the separate total duty cycle that results for each to achieve the maximum flux at the target color point.

In one embodiment, color points or flux of light sources 110 change with time, use, and/or temperature. For example, LED drive currents or duty cycles can affect light source temperature, which in turn affects the output wavelength of the light source. In one embodiment, temperature sensor 125 senses the temperature and photosensitive detector 120 senses the flux of at least one light source 110 and provides this information to controller 115. Based on sensed temperature feedback, controller 115 predicts future light source temperature, and adjusts the color points of light sources 110 to account for estimated future temperature fluctuations. Based on the sensed flux information and calibrated (e.g., factory determined) flux values of light sources 110, controller 115 can determine that the duty cycle ratios of light sources 110 with respect to each other are changing, or will change, and can adjust the duty cycles of light sources 110 keep their ratios constant to maintain maximum flux at the target color point. According to one embodiment, temperature sensor 125 monitors a temperature of a substrate on which the light source is mounted.

Light sources 110 may include at least one compound light source. For example, controller 115 can generate a compound light source based on the color points and flux values of two or more light sources. For example, red (R) light source 110 and amber (A) light source 110 are relatively close to each other in the gamut of FIG. 3 when compared to blue, green, or white light sources 110. Controller 115 may generate a compound light source located between red and amber light sources 110, for example by summing the fluxes and determining a color point closest to these two light sources 110. By merging red and amber (or any other) combination of light sources 110 into a single compound light source, the number of light sources 110 is effectively reduced by at least one, for example, from five to four. This approach reduces the number of possible primary color combinations that cover the target color point, and thus the amount of information that is processed by controller 115. For example in Table 2, where the compound light source is represented with a “C.”

TABLE 2
Within Gamut?

| | | | |
|---|---|---|---|
| BGW | GCW | BCW | BGC |
| No | No | Yes | Yes |

With reference to Tables 1 and 2, merging red and amber light sources 110 into a compound light source reduces the number of matching combination from four to two. In Table 2, with red (R) and amber (A) light sources 110 represented by compound light source C, the combination that match the target color point are BCW (blue, compound, white) and BGC (blue, green, compound). In one embodiment, controller 115 then ranks the matching combinations from highest to lowest flux, determines the duty cycle of each light source for each matching combination. If the sum of the duty cycles is greater then one, the highest ranked combination is selected, its duty cycles are identified and subtracted against the duty cycle budget of 1. The remaining duty cycle budget is applied to the next highest ranked (by flux) of the matching combinations, scaled if necessary to maintain the total duty cycles for each color in the combinations within budget. The resulting duty cycles are summed for each light source 110 for all of the matching combinations, with the budget of 1 being the maximum duty cycle. In one embodiment, controller 115 applies the duty cycle of the compound light source to the two (or more) light sources from which it was generated, e.g., red and amber in the example of Table 2.

In one embodiment, illumination system 100 includes blue, green, amber, red, and white (e.g. neutral white) light sources 110 with saturated colors of at least 148 lm for blue, 1700 lm for green, 873 lm for amber, 709 lm for red, and 4700 lm for white. These numbers are examples, and in another embodiment, the luminous flux of light sources 110 is at least 235 lm for blue, 2608 lm for green, 1289 lm for amber, 1048 lm for red, and 5808 lm for white. The color temperature of the light output from lighting unit 105 can vary within a predetermined range. For example, in one embodiment, the light output between 2700K and 6500K.

In one embodiment, illumination system 100 includes blue, green, amber, and red light sources 110 with peak wavelengths of 448.5 nm, 515.9 nm, 599.6 nm, and 642.1 nm, respectively, and a white light source 110 with an (x, y,) color point of (0.3895, 0.3798). In this example, illumination system provides saturated colors having flux values of at least 148 lm for blue, 1700 lm for green, 873 lm for amber, 709 lm for red, and 4700 lm for white. In another example having these wavelengths and color points, the flux values are at least 235 lm for blue, 2608 lm for green, 1289 lm for amber, 1048 lm for red, and 5808 lm for white. In this example, acceptable deviation from the target colored point within the gamut is expressed in equation (1):

Δ(u′v′)=\sqrt{(u′−u′_{Target})²+(v′−v′_{Target})²} (1)

In one embodiment, the standard deviation of color provided by illumination system 100 is less than 5 sdcm in the full range of the color gamut, and different light sources 110 can have different deviations from the target color point. For example, blue, green, amber, and red light sources 110 can deviate from the target color point by 0.001, 0.004, 0.003, and 0.002, respectively.

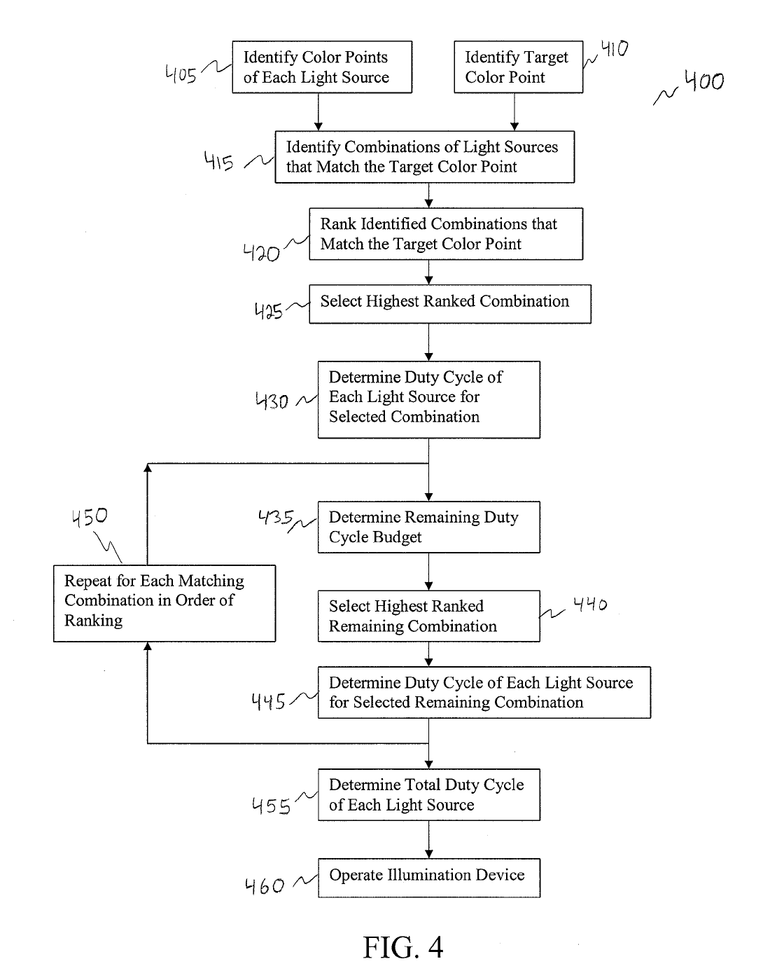

FIG. 4 illustrates a flow chart of a method 400 of providing illumination from a lighting unit. In one embodiment, method 400 includes an act of identifying color points of a plurality of light sources (ACT 405). For example, at least four color points of a primary color light source can be identified (ACT 405) by their (x, y) coordinates on a gamut, or by color temperature. Method 400 also identifies a target color point (ACT 410). For example, an identified target color point may be provided as input into an illumination system, where mixed light output from the system is provided at the target color point. Method 400 also includes an act of identifying combinations of light sources that match the target color point (ACT 415). For example, three light sources form a triangle on a gamut, and combinations of those three light sources can provide light at any color point within that triangle. When the triangle covers the target color point, the corresponding light source combination can achieve light at all points inside the triangle, and thus matches (ACT 415) the target color point. In one embodiment, the identified matching combinations (ACT 415) are ranked (ACT 420). For example, the combinations can be ranked in order of flux, with the matching combination having the highest output ranked first, and the matching combination having the lowest flux ranked last. The highest ranked combination is selected (ACT 425), and the duty cycles of each light source that forms part of the combination is determined (ACT 430). The remaining duty cycle budget can be determined (ACT 435), for example by subtracting the light source duty cycles of the first selected combination from an initial duty cycle budget of one, and method 400 can proceed by selecting the next highest ranked remaining combination (ACT 440). For example, method 400 can proceed by selecting the remaining matching combination with the next highest flux, after the previously selected combination. The duty cycle of each light source of the selected remaining combination can be determined (ACT 445), and the budget determination (ACT 435), remaining combination selection (ACT 440), and duty cycle determination (ACT 445) process may repeat for each matching combination in the order of their flux-based ranking (ACT 450).

In one embodiment, method 400 includes an act of determining the total duty cycle for each light source (ACT 455). For example, the total duty cycle can be determined (ACT 455) by summing the determined duty cycles of the light sources the first selected combination (ACT 430) and each remaining combination (ACT 445). The light sources can then be operated (ACT 460) at their determined (ACT 455) duty cycles to provide mixed output light with the highest achievable flux at the desired target point.

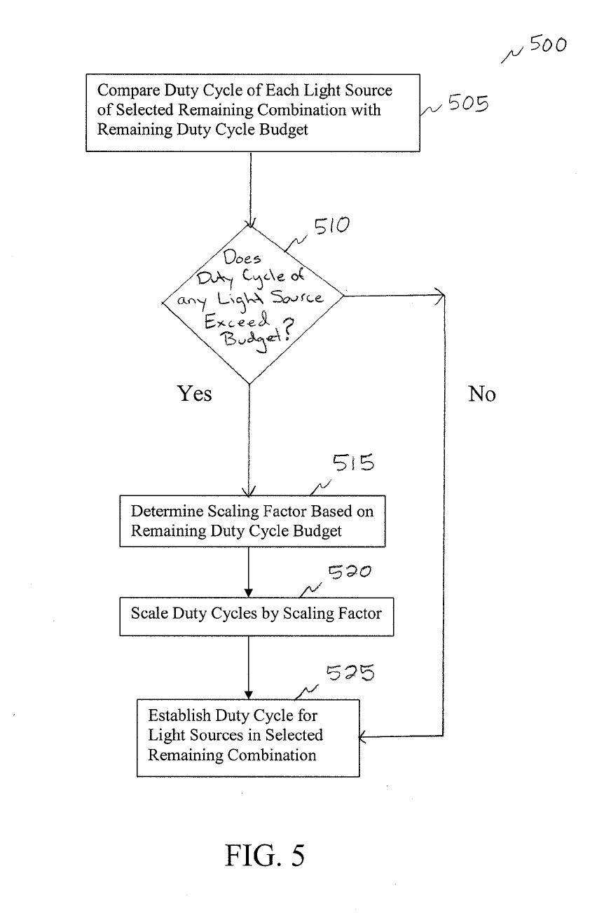

FIG. 5 illustrates a flow chart of a method 500 of providing illumination from a lighting unit. Method 500 generally illustrates duty cycle allocation to the light sources of each matching combination, which in one embodiment occurs for each matching combination in the order of ranking, from highest to lowest (ACT 450). In one embodiment, with a plurality of matching light source combinations, method 500 includes an act of comparing duty cycles of each light source with a budgeted duty cycle (ACT 505). For example, the duty cycles of the first selected matching combination are subtracted from an initial budget of 1, which represents the maximum duty cycle, with the difference being the remaining duty cycle. The duty cycles of remaining combinations are then compared (ACT 505) with the remaining duty cycle budget, and it is determined whether or not the duty cycle of any light source of the remaining combination exceeds the budget (ACT 510). If it is determined that the budget is exceeded, a scaling factor is determined (ACT 515), and the duty cycles of all the light sources included in the selected combination are scaled down by the scaling factor to fit within the budget. This dims the light resulting from the selected, scaled combination. In this example, duty cycles are then established for the light sources of the selected remaining combination (ACT 525), with or without scaling depending on the results of the preceding acts.

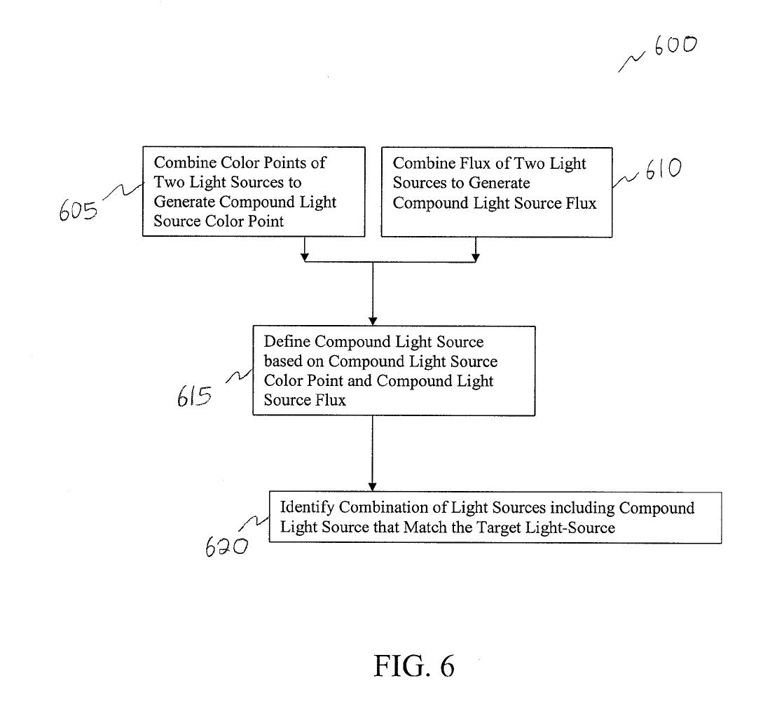

FIG. 6 illustrates a flow chart of a method 600 of providing illumination from a lighting unit. According to some embodiments, method 600 is part of the act of identifying combinations of light sources that match the target color point (ACT 415). In one embodiment, method 600 includes acts of combining color points of a plurality of light sources (ACT 605) to generate a compound color point, and combining flux of a plurality of light sources (ACT 610) to generate a compound flux value. A compound light source is defined (ACT 615) by the combined light source color point and flux values. Its duty cycle, flux, and color points can be determined or adjusted as with any other primary color light source. In one embodiment, the compound color source is used as an estimate for two light sources close to each other on a gamut, such as blue and cyan color sources, or red and amber color sources. In one embodiment, method 600 identifies light source combinations that include at least one compound light source that match the target color point (620) and ranks the matching combinations that include compound light sources together with any matching combinations that include non-compound light sources (e.g., R, G, B, etc.), based on their respective flux values.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

Any reference numerals or other characters, appearing between parentheses in the claims, are provided merely for convenience and are not intended to limit the claims in any way.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. An illumination system, comprising:
a reflector;
at least four solid state light sources, each solid state light source operable to emit light through the reflector; and
a controller configured to identify a plurality of combinations of the at least four solid state light sources, wherein each of the plurality of combinations is operable to emit light that matches a target color point, and wherein the controller is configured to rank the plurality of combinations based on a respective luminous flux value of each of the plurality of combinations, and to select one of the plurality of combinations based on the rank; and to determine a duty cycle of a control signal of each light source of the selected combination to control light emitted from the reflector by the selected combination.

2. The illumination system of claim 1, wherein the selected one of the plurality of combinations emits light having a luminous flux value greater than the respective luminous flux value emitted by each of the other of the plurality of combinations.

3. The illumination system of claim 1, wherein the controller is configured to:
determine a duty cycle budget based on the duty cycle of each light source of the selected combination;
select a second of the plurality of combinations based on the rank; and
determine a duty cycle of each light source of the second selected combination based on the duty cycle budget.

4. The illumination system of claim 3, wherein the controller is configured to determine a total duty cycle of each of the at least four light sources based on the duty cycle of each light source of the selected combination and the duty cycle of each light source of the second selected combination.

5. The illumination system of claim 1, wherein for each of the at least four light sources the controller is configured to determine that a cumulative duty cycle provided by the plurality of combinations is greater than one.

6. The illumination system of claim 1, wherein the controller is configured to:
define a compound light source based on two of the at least four light sources;
identify a luminous flux value of the compound light source based on luminous flux of the two light sources;
determine a duty cycle of the compound light source; and
employ the compound light source in combination with at least two of the at least four light sources that form the plurality of combinations.

7. The illumination system of claim 1, comprising:
a photosensitive detector, wherein the reflector is a tubular reflector that includes a lightguide configured to provide light from at least one of the at least four light sources to the photosensitive detector.

8. The illumination system of claim 1, wherein each of the at least four light sources emit a different primary color of light, and wherein each of the at least four light sources includes at least one light emitting diode.

9. A method of providing illumination from a lighting source having a plurality of solid state light sources, comprising:
identifying a plurality of combinations of the plurality of solid state light sources, wherein each of the plurality of combinations is operable to emit light that matches a target color point;
ranking the plurality of combinations based on a respective luminous flux value of each of the plurality of combinations;
selecting one of the plurality of combinations as a selected combination based on the ranking;
determining a duty cycle of a control signal of each light source of the selected combination; and
modulating the duty cycle of each light source of the selected combination to control light emitted by the selected combination.

10. The method of claim 9, comprising:
determining that a luminous flux value of the selected combination is greater than luminous flux values of each remaining combination of the plurality of combinations.

11. The method of claim 9, comprising:
determining a duty cycle budget based on the duty cycle of each light source of the selected combination.

12. The method of claim 11, comprising:
selecting a second of the plurality of combinations based on the ranking; and
determining a duty cycle of each light source of the second selected combination; and
scaling a duty cycle of at least one light source, wherein the at least one light source is common to the selected combination and the second selected combination.

13. The method of claim 9, comprising:
selecting a second of the plurality of combinations based on the rank;
determining a duty cycle of each light source of the second selected combination; and
determining a total duty cycle of each of the plurality of light sources based at least in part on the duty cycle of each light source of the selected combination and the duty cycle of each light source of the second selected combination.

14. The method of claim 9, comprising:
determining that a cumulative duty cycle of at least one of the plurality of light sources provided by at least one of the plurality of combinations is greater than one.

15. The method of claim 9, comprising:
adjusting the duty cycle of each light source of the selected combination to maintain the light emitted by the selected combination at the target color point.

16. The method of claim 9, comprising:
independently modulating control signal duty cycles of each of the plurality of solid state light sources.

17. The method of claim 9, comprising:
determining a total duty cycle of each of the plurality of light sources based on duty cycles of each light source of the each of the plurality of combinations.

18. The method of claim 9, comprising:
defining a compound light source based on two of the plurality of light sources;
determining a luminous flux value of the compound light source based on luminous flux of the two light sources;
determining a duty cycle of the compound light source; and
employing the compound light source in combination with the plurality of light sources that form the plurality of combinations.

19. A computer readable medium encoded with a program for execution on a processor, the program, when executed on the processor performing a method of providing illumination from a lighting source having a plurality of solid state light sources, the method comprising acts of:
identifying multiple combinations of the plurality of solid state light sources, wherein each of the combinations is operable to emit light that matches a target color point;
ranking the combinations based on a respective luminous flux value of each of the combinations;
selecting a plurality of the combinations based on the ranking;
determining individual duty cycles for each light source individually for each of the selected plurality of the combinations;
determining total duty cycles for each light source, based on the individual duty cycles; and
controlling light emitted by the selected combination based on the total duty cycles.

20. The computer readable medium of claim 19, the method further comprising:
comparing the individual duty cycles with a duty cycle budget; and
scaling at least one individual duty cycle to determine at least one total duty cycle.

21. The computer readable medium of claim 19, the method further comprising:
providing light from at least one of the plurality of solid state light sources to a photosensitive detector; and
adjusting at least one of the individual duty cycles based on information received from the photosensitive detector.

22. The computer readable medium of claim 19, the method further comprising:
defining a compound light source based on two of the plurality of light sources;
determining a luminous flux value of the compound light source based on luminous flux of the two light sources;
determining a duty cycle of the compound light source; and
employing the compound light source in combination with the plurality of light sources that form the multiple combinations.
